(19) United States
(12) Patent Application Publication
(10) Pub. No.: US 2002/0062567 A1
(43) Pub. Date: May 30, 2002

(54) Cutting device

(76) Inventors: Travis Nichols, Perry, UT (US); Blake Gustafson, Perry, UT (US)

Correspondence Address: Robert M. Haroun, SOFER & HAROUN, LLP, Suite 1921, 342 Madison Avenue, New York, NY, 10173, US

(21) Appl. No.: 09/727,364

(22) Filed: Nov. 29, 2000

(51) Int. Cl. B26B 3/00

(52) U.S. Cl. 30/294

(57) ABSTRACT

The present invention provides for a cutting device for use with a template to cut a media. The cutting device is comprised of a handle having a first end and a second attachment end and a positioning stem having a mounting stem and a ring portion. The mounting stem is positioned on the second attachment end so that the ring portion is spaced a distance from the second attachment end thereby defining a template notch. A cutting means is rotatably positioned within the ring portion and used to cut the media, and is configured such that when the template notch of the cutting device is inserted into the template, a shape defining edge of the template is received in the template notch.

### FIELD OF THE INVENTION

This invention relates to a cutting device. More specifically, this invention relates to a cutting device used to cut shapes from a template.

### BACKGROUND

Cutting devices, or utility knives used at the present time are suitable for cutting straight lines, curved lines and cutting along edges. There have been many attempts in the past to produce a better cutting device for use with a template or straight edge to produce more accurate cuts shapes from a substrate. Some of these attempts are described below.

U.S. Pat. No. 2,314,327 is directed to providing a glass cutting apparatus which provides a fixed guide block for engagement with a template. U.S. Pat. No. 3,797,340 is directed to a glass cutting device having a template and a follower device for guiding a scoring head along a predetermined path over a work piece whereby to score the work piece along the predetermined path.

U.S. Pat. No. 3,080,653 is directed to a cutting tool with a swivel blade for cutting silk screen stencils. U.S. Pat. No. 4,934,054 is directed to a cutting device for masking film which permits adjustment of the pressing force of the cutter against a mask film. U.S. Pat. No. 2,569,286 is directed to a swivel knife which provides a means for cutting around designs and parts of pictoral illustrations for the object of removing such parts from it surroundings. U.S. Pat. No. 5,175,934 is directed to a utility knife which is switch able between a non-rotatable mode for cutting straight lines and a rotatable mode for cutting curves.

However, even given the large number of cutting devices available for use in conjunction with a template, there still exists a need for a cutting device which is better adapted for maintaining engagement with a shape defining edge of a template when cutting patterns. The present invention is directed at solving this problem by providing a cutting device which is better adapted to maintain a smooth connection with a shape defining edge of a template throughout the entire cut, regardless of the shape or intricacy of the shape defined by the shape defining edge.

### SUMMARY

It is a first object of the present invention to provide a cutting device for use with a template to cut a media. The cutting device is comprised of a handle having a first end and a second attachment end and a positioning stem having a mounting stem and a ring portion. The mounting stem is positioned on the second attachment end so that the ring portion is spaced a distance from the second attachment end thereby defining a template notch.

The cutting device further comprises a cutting means rotatably positioned within the ring portion used to cut the media, and is configured such that when the template notch of the cutting device is inserted into the template, a shape defining edge of the template is received in the template notch.

It is an object of the present invention to provide a cutting device where the second attachment end of the handle is further comprised of a handle recess used to receive the mounting stem of the positioning stem.

It is an object of the present invention to provide a cutting device where the ring portion of the positioning stem is a ball bearing.

It is an object of the present invention to provide a cutting device where the cutting means is a knife having an angled blade to facilitate the alignment of the knife along the shape defining edge of the template during operation and where the cutting means is removably attached to the ring portion of the mounting stem.

It is an object of the present invention to provide a cutting device where the handle is cylindrical and is constructed of a rigid transparent material such as Lucite.

It is an object of the present invention to provide a cutting device further comprised of a cap for positioning over the second attachment end of the handle so that the positioning stem and cutting means are protected. The cap has a blade notch for use in removing the cutting means from the ring positioning of the positioning stem.

It is an object of the present invention to provide a cutting device which is further comprised of a removable stand which is positioned over the first end of the handle so as to facilitate storage when the cutting device is not in use.

### BRIEF DESCRIPTION OF THE DRAWINGS

FIG. 1. is a front elevation view of a handle of a cutting device, in accordance with one embodiment of the present invention;

FIG. 2. is a close up view of a positioning stem, in accordance with one embodiment of the present invention;

FIG. 3. is a close up view of a positioning stem inserted into a handle recess of a handle, in accordance with one embodiment of the present invention;

FIG. 4. is a close up view of a knife tool inserted into a positioning stem, in accordance with one embodiment of the present invention;

FIG. 5. is a front elevation view of a handle of a cutting device, in accordance with one embodiment of the present invention;

FIG. 6. is a close up view of a ring insert, in accordance with one embodiment of the present invention;

FIG. 7. is a close up view of a ring insert positioned within a handle recess of a handle, in accordance with one embodiment of the present invention;

FIG. 8. is a close up view of a knife tool, in accordance with one embodiment of the present invention;

FIG. 9. is a close up view of a knife tool inserted into a ring insert, in accordance with one embodiment of the present invention;

FIG. 10. is a close up view of a cap, in accordance with one embodiment of the present invention;

FIG. 11. is a front elevation view of cutting device with a cap and removable stand, in accordance with one embodiment of the present invention;

FIG. 12A. is a close up view of a cap with blade notch engaging a knife tool, in accordance with one embodiment of the present invention;

FIG. 12B. is a close up view of a cap with blade notch engaging a knife tool, in accordance with one embodiment of the present invention;

FIG. 13. is a flow chart of the operation of a cutting device, in accordance with one embodiment of the present invention;

FIG. 14. is a close up of a template, in accordance with one embodiment of the present invention;

FIG. 15. is a close up of a cutting device with a template notch engaged with a shape defining edge of a template, in accordance with one embodiment of the present invention;

FIG. 16A. is a diagram of a template a media and a cutting device in operation, in accordance with one embodiment of the present invention; and

FIG. 16B. is a diagram of a template a media and a cutting device in operation, in accordance with one embodiment of the present invention.

### DETAILED DESCRIPTION

In one embodiment of the present invention, a cutting device 2 is formed which is used to cut shapes into a media 4 such as paper or cardstock. Using cutting device 2 and a template 6, shapes of various design can be cut from media 4 by simply moving cutting device 2 around a shape defining edge 8 set within template 6. Any media 4 which can readily be cut by cutting device 2 including but not limited to paper, cardstock, vinyl, Mylar or any other media used for crafts, hobbies or business is contemplated by this invention.

First Embodiment

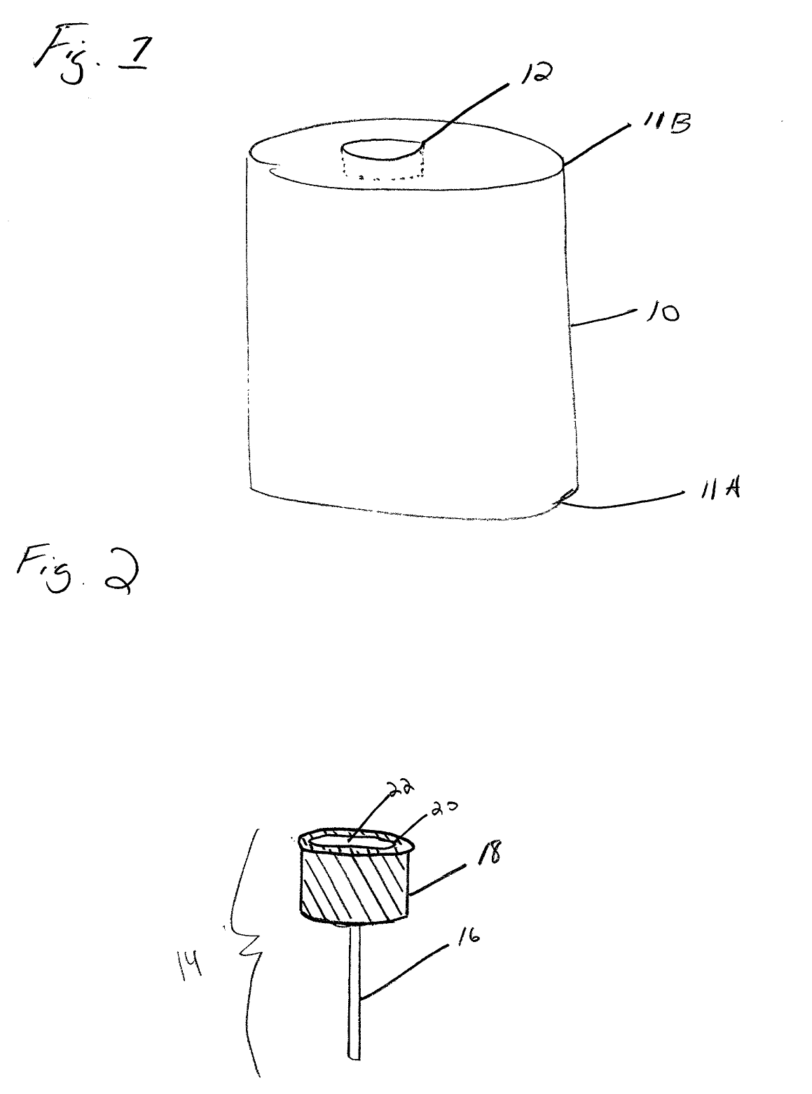

As illustrated in FIG. 1, a handle 10 is displayed having a cylindrical shape, having a first end 11A, a second attachment end 11B and a handle recess 12 disposed at second attachment end 11B. Handle 10 is preferably cylindrically shaped to provide comfortable use and handling, however, handle 10 can be of any shape or size that is conducive for use as a cutting device.

Handle 10 is preferably constructed of a clear plastic or polymer to provide stability and durability to the product. Additionally, use of a clear material for handle 10 allows a user to look down through the axis of handle 10 to facilitate the operation of cutting device 2 by providing a clear view of the connection between cutting device 2 and template 6.

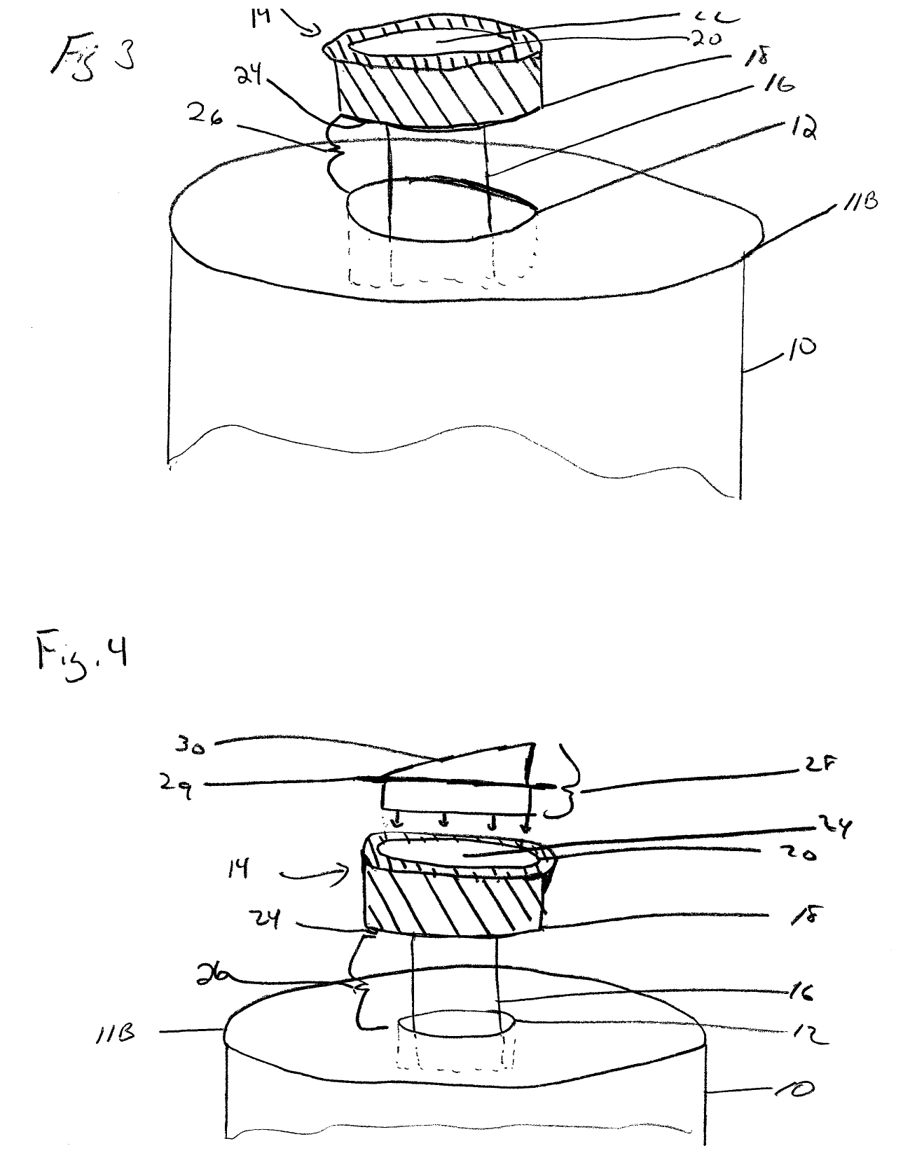

As illustrated in FIG. 2, a positioning stem 14 is comprised of a mounting stem 16 and bearing ring portion 18, ring portion 18 having an inner ring 20 defining a bore 22. Because bearing ring portion 18 of positioning stem 14 is of a wider diameter than mounting stem 16, a lip 24 is formed.

As shown in FIG. 3 mounting stem 16 is inserted into bearing recess 12 and fixed in place such that positioning stem 14 does not move relative to handle 10. Mounting stem 16 is of such a length that when fully fixed into handle recess 12, mounting stem 16 extends beyond the surface of second attachment end 11B handle 10 such that ring portion 18 is disposed at a distance from the surface second attachment end 11B. As such, a template notch 26 is formed between lip 24 of positioning stem 14 and handle 10.

When mounting stem 16 is inserted and fixed into bearing recess 12 of handle 10, it is configured such that mounting stem 16 and thus all of positioning stem 14 does not rotate during operation. This can be achieved in many ways. For example, a glue or cement can be used to fix mounting stem 16. Alternatively, the outer surface of mounting stem 16 or the inner surface of bearing recess 12 may have a non-slip surface disposed thereon preventing slippage during operation. In this configuration, positioning stem 14 could be replaceable with other positioning stem 14. Any such method of attachment between mounting stem 16 of positioning stem 14 and handle recess 12 that prevents rotational slippage during operation is within the contemplation of the present invention.

It should be noted that an alternative design is available where mounting stem 16 is attached directly to the face of second attachment end 11B of handle 10 without the use of handle recess 12. Although the design of this alternative configuration is different, it is functionally equivalent and maintains an substantially similar template notch 26 the principle operative element of the present invention.

Template notch 26 is has an upper boundary of lip 24, a side boundary of mounting stem 16 and a lower boundary of second attachment end 11B. Preferably, template notch 26 is about 2-3 mm thick providing the ability for connection with template 6 that both allows for fluid movement about shape defining opening 8 of template 6 and still remains close enough to maintain connection with template 6 through out the cutting process. The 2 mm thickness of template notch 26 is intended only as a sample thickness and is in no way intended to limit the scope of the invention, any thickness of template notch 26 which facilitates the operation of cutting device 2 is within the contemplation of the present invention.

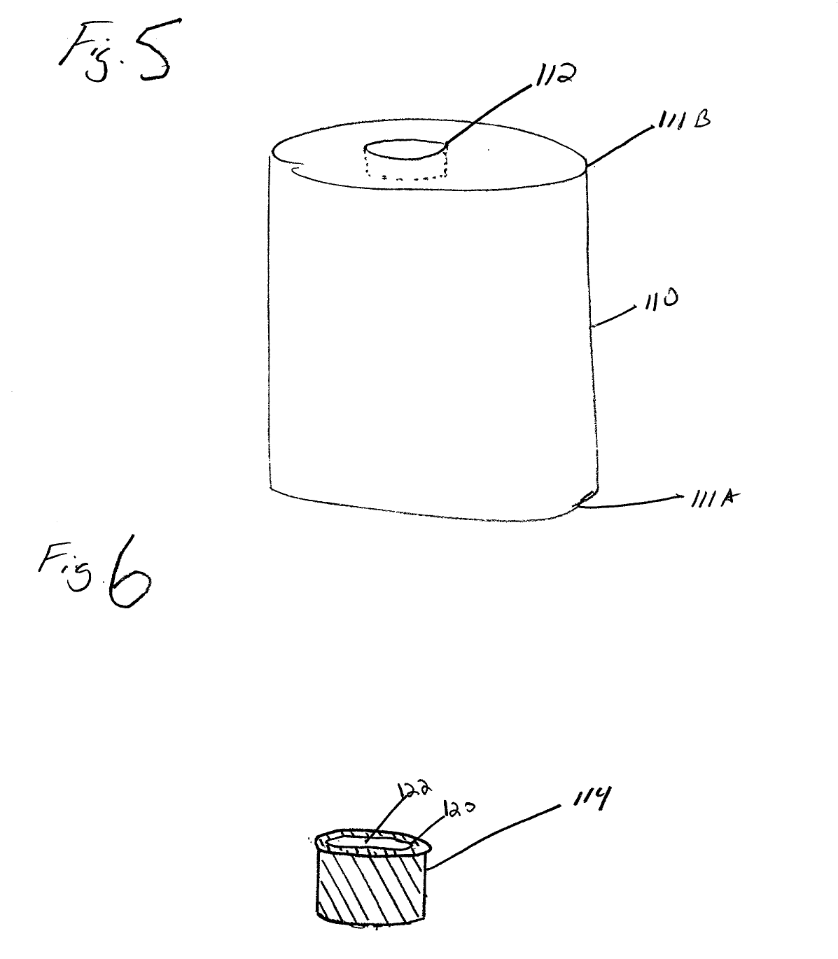

As illustrated in FIG. 4 a knife tool 28 is inserted into bore 22 of positioning stem 14 such that the outer walls of knife tool 28 are affixed against inner ring 20 of ring portion 18. As such, when knife tool 28 is inserted, it can be easily rotated about an axis which runs parallel to the length axis of handle 10. This allows knife tool 28 to swivel 360° so as to facilitate the cutting of shapes from template 6 without requiring the user to change hand positions when a new edge of shape defining opening 8 is engaged.

Knife tool 28 is comprised of a blade flange 29 and a blade portion 30. Blade portion 30 of knife tool 28 is disposed on blade flange 29 and is advantageously wedge shaped so that when cutting device 2 is moved around shape defining edge 8 knife tool 28 will automatically adjust to align the cutting edge of blade portion 30 to be in alignment along the edge of shape defining edge 8. This configuration allows knife tool 28 to accurately cut a shape from media 4 as will be described in more detail below.

The mounting of cutting tool 28 in positioning stem 14 which allows for rotational movement, in conjunction with the wedge shaped design of blade portion 30, imparts the ability to cutting tool 28 to automatically align itself such that the cutting edge of blade portion 30 will always be parallel to the edge of shape defining edge 8 that is currently being cut. This configuration ensures a smooth continuous cut pattern from paper or cardstock 4.

Second embodiment

As illustrated in FIG. 5 a handle 110 is displayed having a cylindrical shape and having a first end 111A, a second attachment end 111B and a handle recess 112 disposed at second attachment end 111B. Handle 110 is preferably cylindrically shaped to provide comfortable use and handling, however, handle 110 can be of any shape or size that is conducive for use as in cutting device 102.

Handle 110 is preferably constructed of a clear plastic or polymer to provide stability and durability to the product. Additionally, use of clear material for handle 110 allows a user to look down through the axis of handle 110 during to facilitate the operation of cutting device 102 by allowing a clear view of the connection between cutting device 102 and template 106.

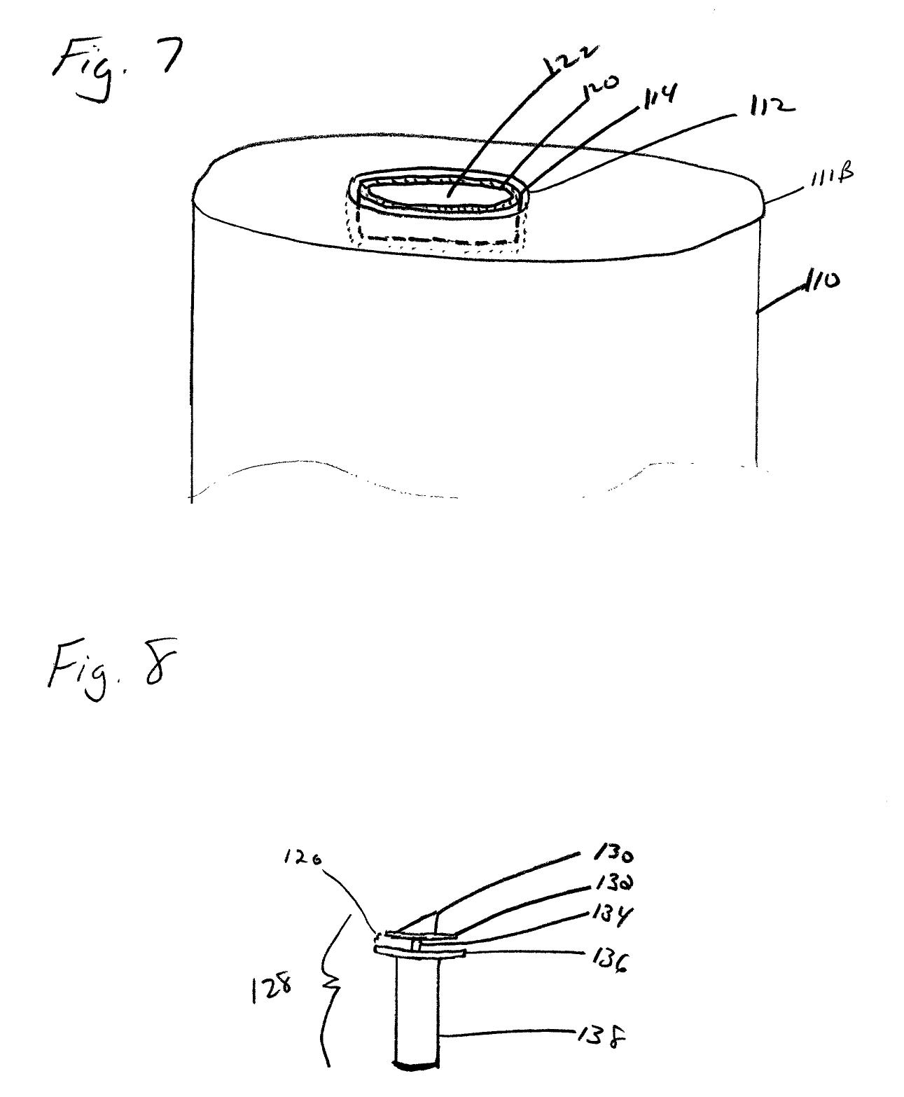

As illustrated in FIG. 6 a ring insert 114 is provided having an inner ring 120 defining a bore 122. As shown in FIG. 7 ring insert 114 is inserted into handle recess 112 and fixed in place such that ring insert 114 does not move relative to handle 110. Handle recess 112 is of such a depth such that when ring insert 114 is fully inserted into handle recess 112 the top of ring insert 114 is substantially flush with the surface of second attachment end 111B of handle 110.

When ring insert 114 is inserted and fixed into handle recess 112 of handle 110, it is configured such that ring insert 114 does not rotate during operation. This can be achieved in many ways. For example, a glue or cement can be used to fix ring insert 114. Alternatively, the outer surface of ring insert 114 or the inner surface of handle recess 112 may have a non-slip surface disposed thereon preventing slippage during operation. In this configuration ring insert 114 could be replaceable with other ring insert 114. Any such method of attachment between ring insert 114 and handle recess 112 that prevents rotational slippage during operation is within the contemplation of the present invention.

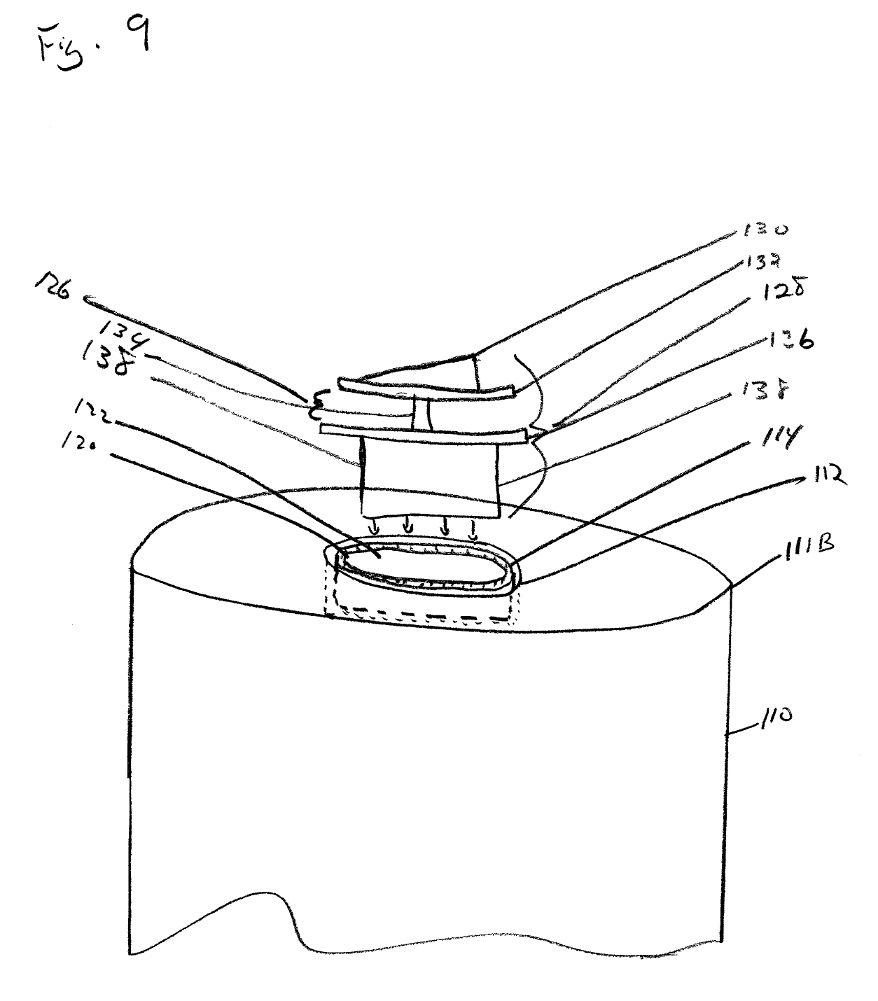

As illustrated in FIG. 8 a knife tool 128 is comprised of a blade portion 130, a blade portion flange 132, an inter-flange stem 134, a stem flange 136 and a mounting stem 138. A template notch 126 is formed between knife portion flange 132 and stem flange 136.

Template notch 126 is has an upper boundary of blade portion flange 132, a side boundary of mounting inter-flange stem 134 and a lower boundary of stem flange 136. Preferably, template notch 126 is about 2 mm thick providing the ability for connection with template 6 that both allows for fluid movement about shape defining opening 8 of template 6 and still remains close enough to maintain connection with template 6 through out the cutting process. The 2 mm thickness of template notch 126 is intended only as a sample thickness and is in no way intended to limit the scope of the invention, any thickness of template notch 126 which facilitates the operation of cutting device 2 is within the contemplation of the present invention.

In this embodiment it should be noted that template notch 126 rotates during operation. However, because template notch 126 is circularly structured about an axis which coincides with inter-flange stem 134. This design advantageously allows template notch 126 to stay in contact with shape defining edge 8 of template 6 throughout the cutting operation.

Knife tool 128 has a blade portion 130 advantageously shaped as a wedge so that when cutting device 2 is moved around shape defining edge 8 knife tool 128 will automatically adjust to align the cutting edge of knife portion 130 to be in alignment along the edge of shape defining edge 8. This configuration allows knife tool 128 to accurately cut a shape from media 4 as will be described in more detail below.

As illustrated in FIG. 9 a knife tool 128 is inserted in to bore 122 of ring insert 114 such that the mounting stem 138 of knife tool 128 is affixed against inner ring 120 of ring insert 114. As such, when knife tool 128 is inserted, it can be easily rotated about an axis which runs parallel to the length axis of handle 110. This allows knife tool 128 to swivel 360° so as to facilitate the cutting of shapes from template 6 without requiring the user to change hand positions when a new edge of shape defining edge 8 is engaged.

The mounting of cutting tool 128 in ring insert 114 which allows for rotational movement, in conjunction with the wedge shaped design of blade portion 130, imparts the ability to cutting tool 128 to automatically align itself such that the cutting edge of blade portion 130 will always be parallel to the edge of shape defining edge 8 that is currently being cut. This configuration ensures a smooth continuous cut pattern from media 4.

Other embodiments

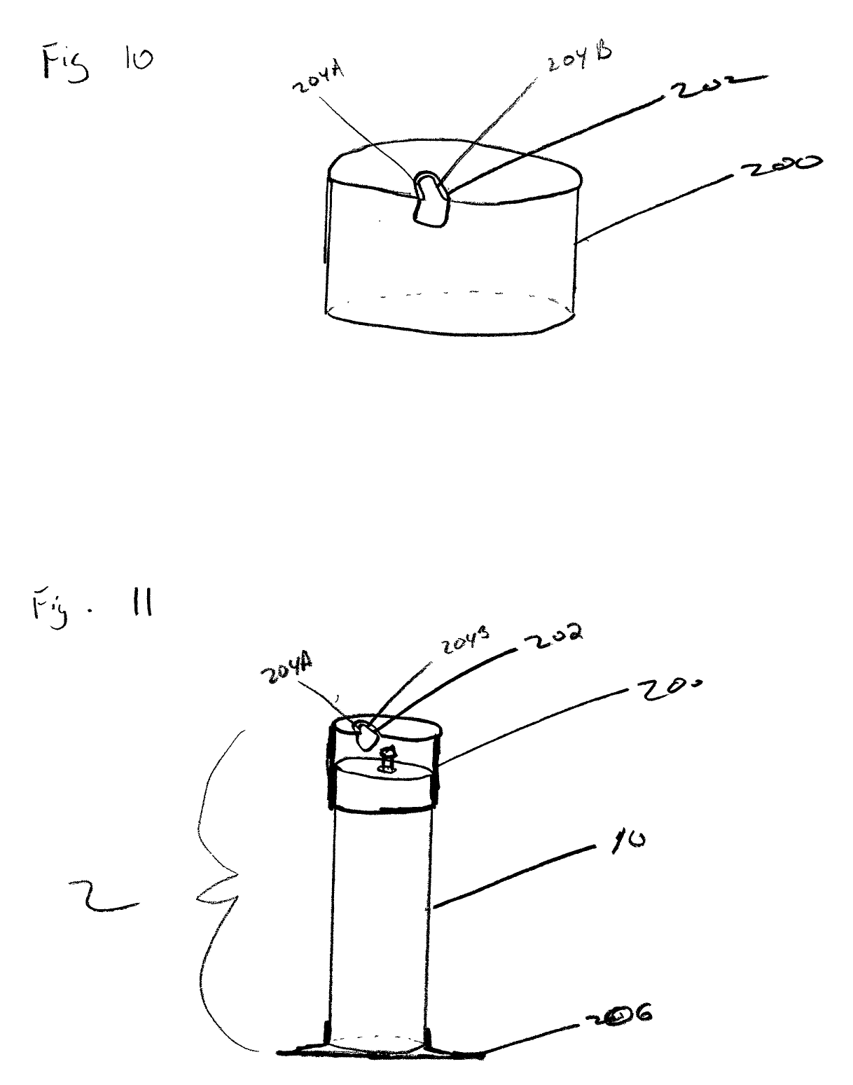

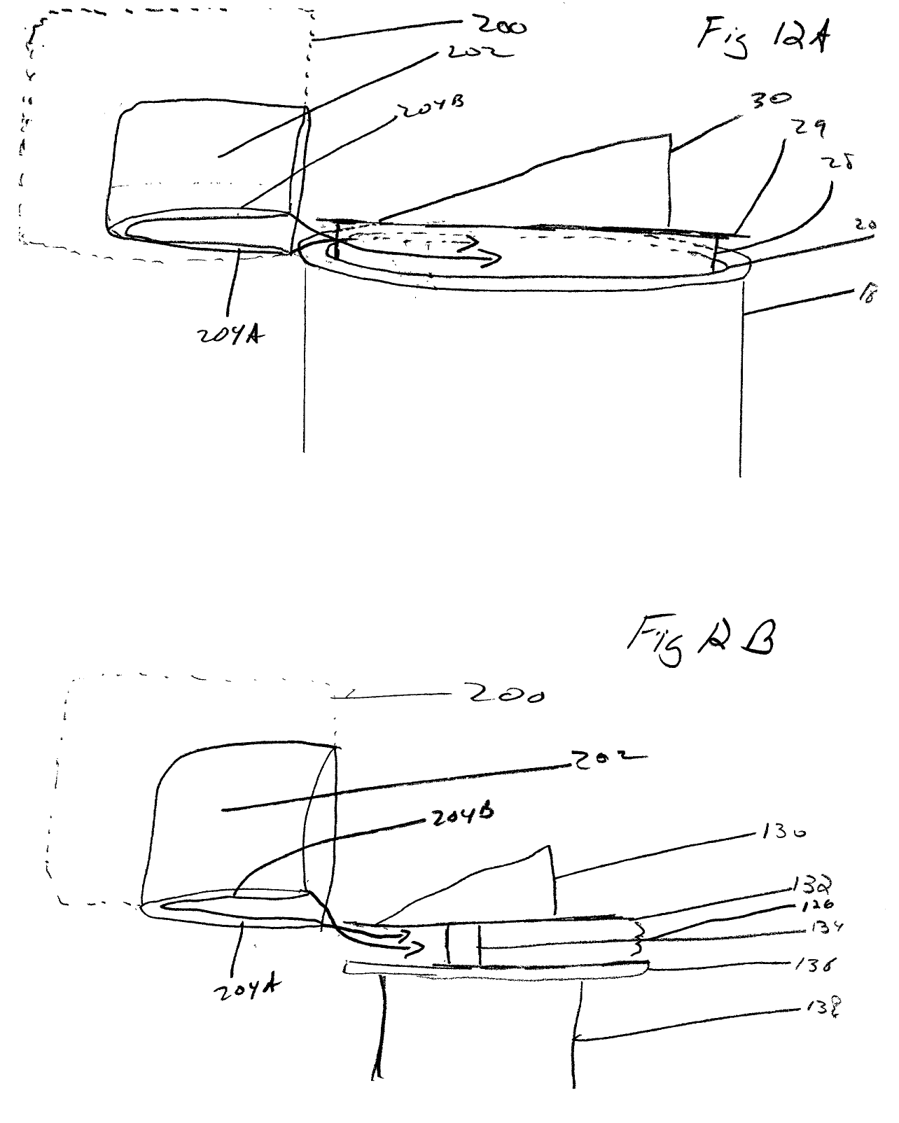

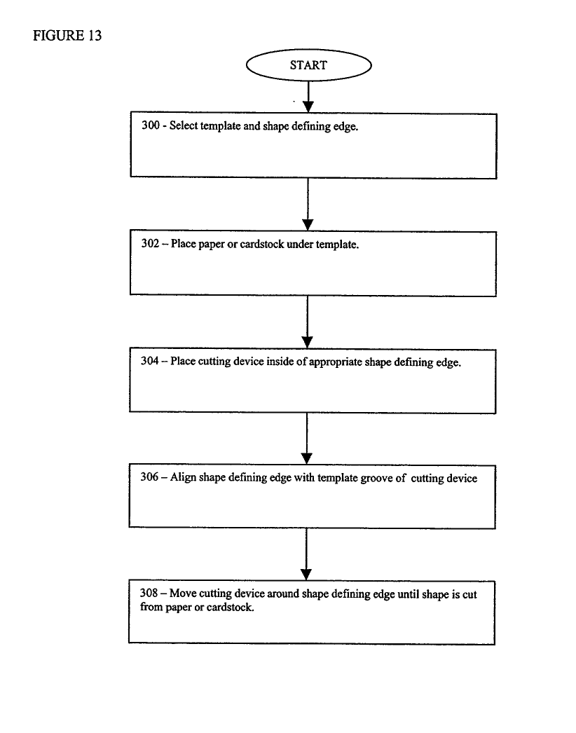

As illustrated in FIG. 10 a cap 200 is provided so as to prevent accidentally cutting when cutting device 2 is not in operation. To this end, when cutting device 2 is not in use cap 200, having a diameter slightly larger than that of handle 10 or handle 110, is placed on the end of handle 10 or handle 110 that maintains the cutting apparatus, as shown in FIG. 11.

Additionally, as illustrated in FIGS. 10 and 11 cap 200 is provided with a blade notch 202. As seen in FIG. 10 blade notch 202 is provided with clip edges 204a and 204b. In both embodiments of cutting device 2, knife tool 28 and knife tool 128 may be removable, such that knife tools 28 and 128 can be removed from ring portion 18 of positioning stem 14 or ring insert 114. To this end, to facilitate removal, blade notch 202 can be engaged with knife tools 28 and 128.

As illustrated in FIG. 12A, in the case of knife tool 28, blade notch 202 is slid over knife tool 28 such that clip edges 204a and 204b are disposed underneath blade flange 29, but above the upper surface of bearing 14. By pulling upward on cap 200, clip edges 204a and 204b will remove knife tool 28 from inner ring 20 of bearing 14.

As illustrate din FIG. 12B, in the case of knife tool 128, blade notch 202 is slid over knife tool 128 such that clip edges 204a and 204b are disposed underneath blade portion flange 132, but above the upper surface of stem flange 136. By pulling upward on cap 200, clip edges 204a and 204b will remove knife tool 128 from inner ring 120 of bearing 114.

In another embodiment of the present invention, as illustrated in FIG. 11 a removable stand 206 is provided such that during periods of in-operation of cutting device 2, stand 206 supports device 2 in an upright position so as to facilitate the easy retrieval. Additionally, because the preferred shape of handles 10 and 110 is a cylinder, use of cutting device 2 on a flat non-horizontal surface such as a drafting table, would cause cutting device to roll. The use of removable stand 206 facilitates the standing of handles 10 and 110 on their end surfaces by providing a support in the form of an extended radius base.

Operation of cutting device

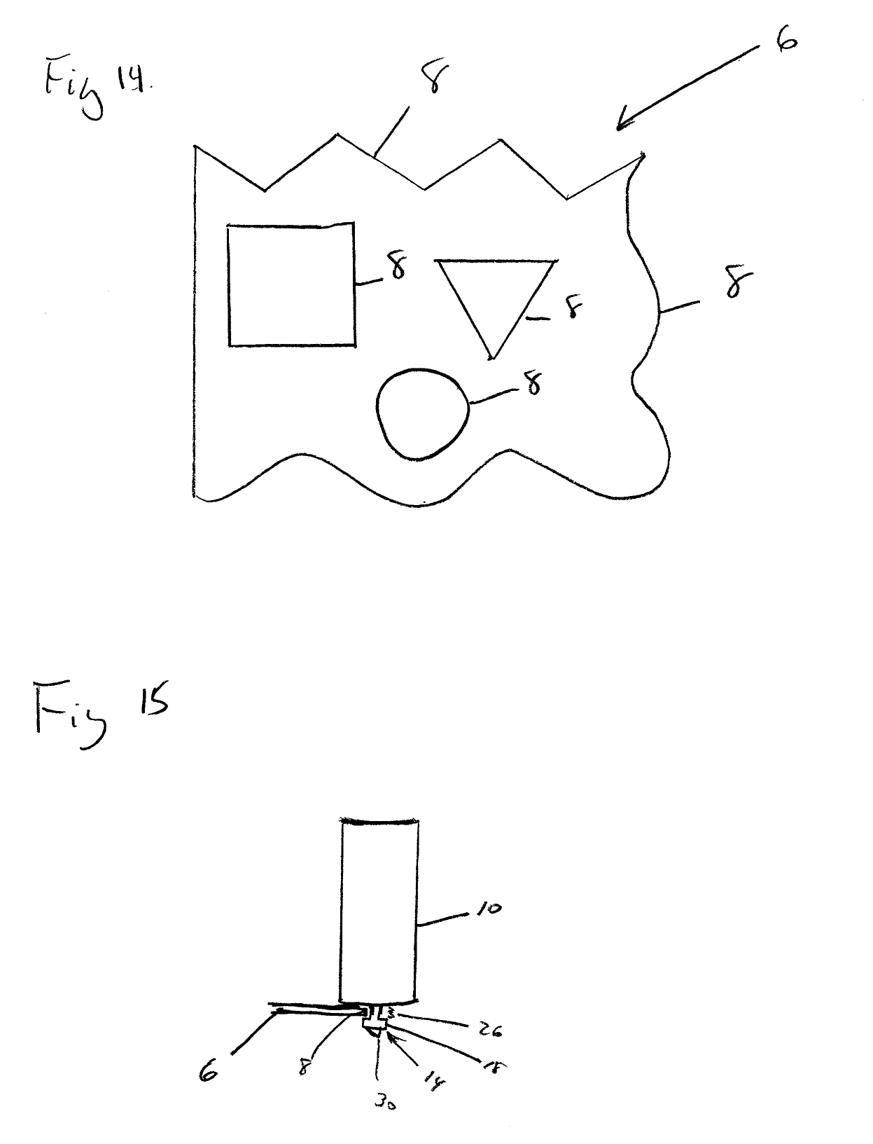

As illustrated in Flow Chart 13, the operation of cutting device 2, Step 300 involves the selection of a template 6 and a particular shape defining edge 8. As more clearly illustrated in FIG. 14, template 6 can be of any size or shape so long as it is conducive for use with cutting device 2. To this end shape defining edge 8 can be of any size and shape such that it is conducive for use with cutting device 2. The thickness of shape defining edge 8 is not typically of a thickness greater than template notch 26. Although template notch 26 is preferably between 2 and 3 mm thick, the invention is not limited in this respect. Many different cutting devices 2 and template notches 26 can be formed of increased and decreased thickness for use on various thickness templates 6. Use of cutting device 2 in conjunction with any thickness template 6 which utilize the salient features of device 2 is within the contemplation of the present invention.

It should be noted that the first and second embodiment of cutting device 2 operate in substantially similar fashion so for the purposes of this discussion on operation the features of the first embodiment are used to illustrates the operation of the invention.

At step 302, template 6 is placed on cardstock or paper 4 such that shape defining edge 8 is in place over the desired area. Media 4 may then fixed in position with tape or other such fastening devices. This is done to prevent movement of template 6 during operation and may provide a functional advantage but is not required for operation.

Additionally, template 6 and attached media 4 can be placed on a hard shielding surface such a glass so that when blade portion 30 cuts through media 4 it will not continue on to damage the working surface. Although this is not required for operation, the use of hard shielding surface can prevent blade portion 30 from contacting th underlying work surface both preventing damage to the work surface, and preventing blade portion 30 from aberrant movements away from shape defining edge 8.

Next, at step 304, after selecting shape defining edge 8, cutting device 2 is placed such that it is inside the shape or along the edge of the shape (in the case of borders). At step 306 the user aligns shape defining edge 8 such that it engages template groove 26, as shown in greater detail in FIG. 15.

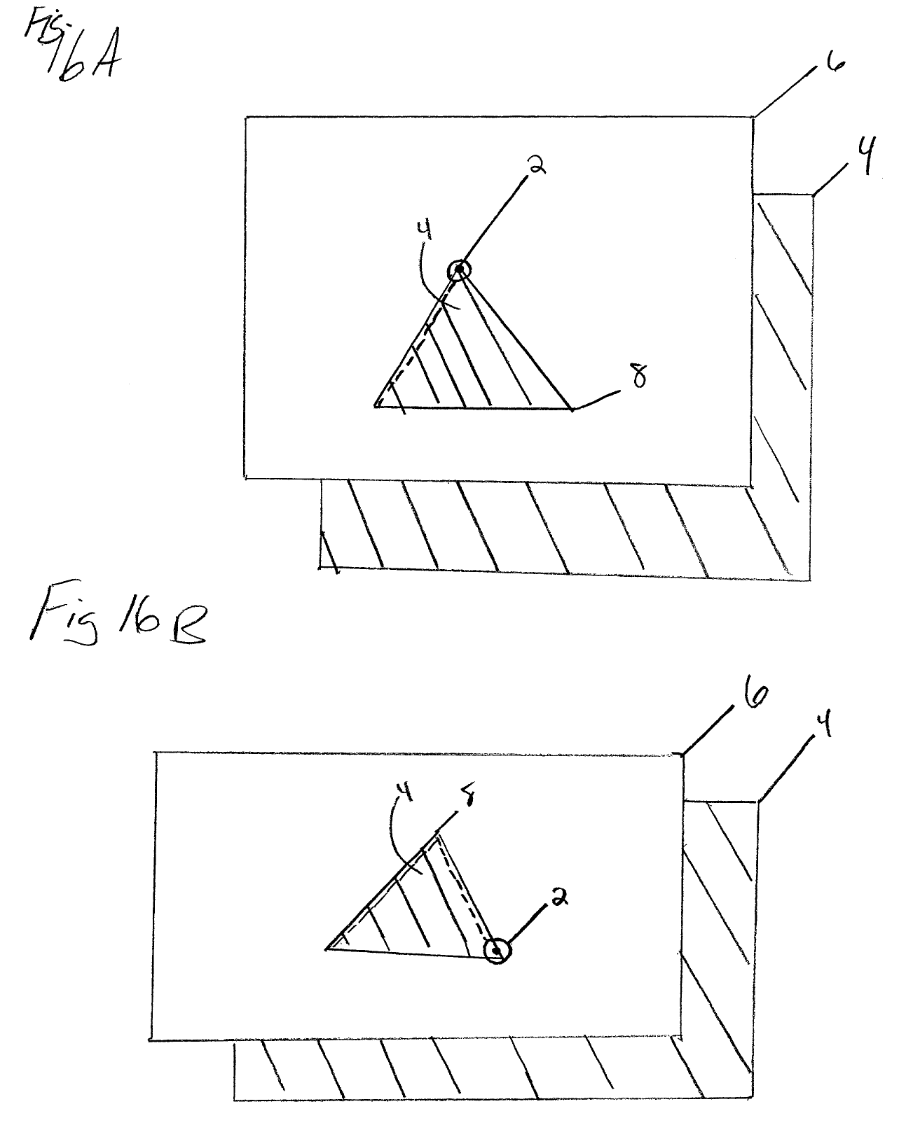

At step 308, cutting device is moved along the distance of shape defining edge 8 in a smooth continuous motion until an abrupt angle change is detected, as illustrated in FIG. 16A. If shape defining edge 8 is a circle there is only one motion necessary, however, in the case of triangles and squares more care needs to be used. When a new edge of direction of shape defining edge is detected cutting device 2 is stopped momentarily, then the user begins to draw cutting device 2 along the next edge, as illustrated in FIG. 16B. This process is continued as long as desired or until cutting device 2 returns to its starting position and thus cuts the entire shape out of media 4.

While only certain features of the invention have been illustrated and described herein, many modifications, substitutions, changes or equivalents will now occur to those skilled in the art. It is therefore, to be understood that this application is intended to cover all such modifications and changes that fall within the true spirit of the invention.

What is claimed is:

1. A cutting device for use with a template to cut a media, said cutting device comprising:
a handle having a first end and a second attachment end;
a positioning stem having a mounting stem and a ring portion, said mounting stem positioned on said second attachment end so that said ring portion is spaced a distance from said second attachment end and defines a template notch;
a cutting means rotatably positioned within said ring portion for cutting said media, so that when said template notch of said cutting device is inserted into said template, a shape defining edge of said template is received in said template notch.

2. A cutting device as claimed in claim 1, wherein said second attachment end of said handle further comprises a handle recess, said handle recess being used to receive said mounting stem of said positioning stem.

3. A cutting device as claimed in claim 1, wherein said ring portion of said positioning stem is a ball bearing.

4. A cutting device as claimed in claim 1, wherein said cutting means is a knife.

5. A cutting device as claimed in claim 4, wherein said knife has an angled blade to facilitate the alignment of the knife along said shape defining edge of said template during operation.

6. A cutting device as claimed in claim 1, wherein said cutting means is removably attached to said ring portion of said mounting stem.

7. A cutting device as claimed in claim 1, wherein said handle is cylindrical.

8. A cutting device as claimed in claim 1, wherein said handle is constructed of a rigid transparent material such as Lucite.

9. A cutting device as claimed in claim 1, further comprising a cap for positioning over said second attachment end of said handle so that said positioning stem and said cutting means are protected.

10. A cutting device as claimed in claim 9, further comprising a blade notch for use in removing said cutting means from said ring positioning of said positioning stem.

11. A cutting device as claimed in claim 1, further comprising removable stand for positioning over said first end of said handle so as to facilitate storage when said cutting device is not in use.
